(19) United States
(12) Patent Application Publication
(10) Pub. No.: US 2019/0198310 A1
(43) Pub. Date: Jun. 27, 2019

(54) GASKET ASSEMBLIES, UV LAMP SYSTEMS INCLUDING SUCH GASKET ASSEMBLIES, AND RELATED METHODS

(71) Applicant: Heraeus Noblelight America LLC, Gaithersburg, MD (US)

(72) Inventor: Javier E. Pajuelo, Gaithersburg, MD (US)

(21) Appl. No.: 16/223,278

(22) Filed: Dec. 18, 2018

Related U.S. Application Data
(60) Provisional application No. 62/609,860, filed on Dec. 22, 2017.

(51) Int. Cl. H01J 61/36; H01J 65/04; H01J 9/26

(52) U.S. Cl. CPC H01J 61/36; H01J 9/266; H01J 65/042

(57) ABSTRACT

A gasket assembly for use in a UV lamp system is provided. The gasket assembly includes an RF screen, and an elastomeric gasket material affixed to the RF screen.

### FIELD

The invention relates to UV lamp systems, and more particularly, to improved gasket assemblies included in UV lamp systems.

### BACKGROUND

Ultraviolet (UV) lamp systems have been in use for many years in applications such as, for example, UV curing. Many conventional industrial high wattage electrodeless UV curing lamp systems include an elongate lamp (irradiator module) which contains a tubular electrodeless bulb envelope powered by at least one magnetron mounted on waveguides that direct the microwaves (where the microwaves are a form of radio frequency radiation, referred to herein as “RF”) into a reflector cavity. U.S. Pat. No. 4,042,850 illustrates details of an example conventional system, the details of which are incorporated by reference herein.

Typically, magnetrons emit microwaves from an output antenna into a metal waveguide inside the lamp system which directs the RF into a reflector cavity containing the bulb envelope. An electrodeless bulb (e.g., a tubular quartz bulb) is filled with a small amount of mercury, an easily ionized gas such as Argon, along with other additives such as metal halide salts to modify and enhance the spectral output. The electric field generated by the magnetrons excites the gas inside the bulb to high energy levels, vaporizing and ionizing the mercury and additives. The resulting high energy collisions of the vaporized molecules cause the bulb to emit a large amount of UV energy.

Such microwave-excited lamps utilize an RF screen as a safety mechanism to shield microwave radiation leakage. A conventional RF screen assembly consists of many separate pieces assembled together. For example, such RF screen assemblies typically include four support gasket parts, four pieces of metallic braided gasket (typically stainless steel), a sheet of fine mesh RF screen material cut to fit, and a spot welded frame. The pieces of metallic braided gasket are placed around the edges of a frame bracket with two metal strips securing the fine mesh RF screen material. When the RF screen assembly is removed and re-installed (but not replaced with a new assembly during routine maintenance activities), the metallic braided gaskets can become compressed to such a state that a good seal is no longer viable. When this occurs, the lamp systems may shut down due to RF excessive RF leakage. Damage to any one part of the RF screen assembly may result in the entire assembly being completely discarded, because of the difficulty in assembly, and the limited knowledge of the user in connection with the assembly.

Thus, for these and other reasons, it would be desirable to improved gasket assemblies, and UV lamp systems including such improved gasket assemblies.

### SUMMARY

According to an exemplary embodiment of the invention, a gasket assembly for use in a UV lamp system is provided. The gasket assembly includes an RF screen, and an elastomeric gasket material affixed to the RF screen.

According to another exemplary embodiment of the invention, a UV lamp system is provided. The UV lamp system: includes a housing; an electrodeless bulb configured to emit UV energy, the electrodeless bulb being positioned within the housing; and a gasket assembly coupled to the housing adjacent the electrodeless bulb. The gasket assembly includes an RF screen, and an elastomeric gasket material affixed to the RF screen.

According to yet another exemplary embodiment of the invention, a method of assembling a gasket assembly for use in a UV lamp system is provided. The method includes: providing an RF screen; and affixing an elastomeric gasket material to the RF screen.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1A is a perspective view of a UV lamp system in accordance with an exemplary embodiment of the invention;

FIG. 1B is a partially exploded perspective view of the UV lamp system of FIG. 1A;

FIG. 2A is a partially exploded perspective view of elements of a gasket assembly in accordance with an exemplary embodiment of the invention;

FIG. 2B is a top view of the elements of the gasket assembly of FIG. 2A; and

FIG. 2C is a further partially exploded perspective view of the elements of the gasket assembly of FIG. 2A.

### DETAILED DESCRIPTION

In accordance with certain exemplary embodiments of the invention, a gasket assembly is provided including two pieces of elastomeric gasket material (e.g., formed of silicone, a silicone based material, or another elastomeric material) are provided, each on one of two sides of a sheet piece of RF screen material. The pieces of elastomeric gasket material may be affixed to an RF screen, for example, using an adhesive (e.g., an epoxy adhesive). For example, the pieces of elastomeric gasket material may include conductive particles (e.g., graphite or metallic particles). For example, such conductive particles may be coated onto one or more surfaces of the elastomeric gasket material. In another example, such conductive particles may be dispersed throughout the volume of the elastomeric gasket material.

When assembled, such a gasket assembly including the two pieces of elastomeric gasket material and the sheet piece of RF screen material provides a high level of electromagnetic interference (EMI) shielding and environmental sealing over a wide temperature range. While aspects of the invention describe the elastomeric gasket material as “pieces” provided on sides of the RF screen material, it will be appreciated that the elastomeric gasket material may (or may not) be separate pieces of material. Thus, for example: (i) the elastomeric gasket material may be solid pieces of material, to be coupled to the RF screen; (ii) the elastomeric gasket material may be applied to the RF screen while in a non-solid form, where the elastomeric material later solidifies in contact with the RF screen as a single piece; among other potential applications of elastomeric material.

The gasket assembly may be sized to fit into a screen frame to provide a complete seal. In embodiments where the elastomeric gasket material is provided as one or more solid pieces of material, a special high temperature adhesive may be used to adhere the elastomeric gasket material pieces(s) onto the RF screen material, thereby providing a permanent glue seal. In another example, where the elastomeric gasket material is first provided in a non-solid form, the elastomeric gasket material may be applied to the screen material in a mold (e.g., when the gasket material is in a viscous and/or liquid form, such as a silicone based material). In a specific example, the elastomeric material may be affixed to the RF screen using a 3D printing process.

By using a flexible elastomer-based gasket, an improved seal is provided. By using this configuration, if the mesh RF screen were to become damaged, only the RF screen portion of the gasket assembly (including the elastomeric gasket material) would need to be replaced. The RF screen portion of the gasket assembly (including the elastomeric gasket material) is easily removed from the frame member/bracket such that the frame member/bracket is re-useable.

Thus, through the various exemplary embodiments of the invention described herein (and other embodiments within the scope of the invention), improved gasket assemblies (wherein a gasket assembly may also be referred to as a screen assembly or an RF screen assembly) are provided that utilize an elastomeric material encapsulating a portion (e.g., a perimeter) of a fine mesh RF screen and sized to fit into the screen frame member/bracket. By including the conductive particles within (and/or applied to a surface of) the elastomeric material, an electrically conductive gasket is provided that is desirably flexible and pliable. This flexible gasket assembly is then placed within the reusable frame member/bracket and, when installed as part of a UV lamp system (sometimes referred to as a lamp assembly), forms a desirable seal to contain RF radiation.

In exemplary gasket assemblies illustrated herein, two pieces of gasket material encapsulate the edges of the fine mesh RF screen making the entire gasket assembly flexible. The elastomer-based gasket and screen assembly forms a desirable compression seal to reduce RF leakage. This elastomeric gasket/RF screen assembly is a single piece including the RF wire mesh screen sandwiched between two elastomer gaskets pieces. The thickness of the elastomeric gasket material may determine the amount of rigidity. This gasket assembly (the elastomeric material affixed to the RF screen) uses less material since there are fewer pieces. This gasket assembly will allow the mounting bracket (sometimes referred to as a frame member) to be reused thereby reducing replacement cost.

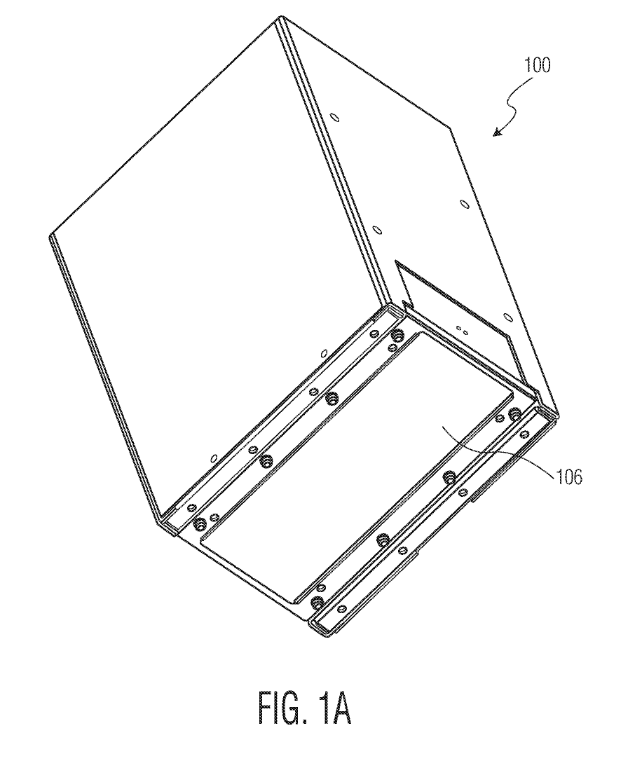

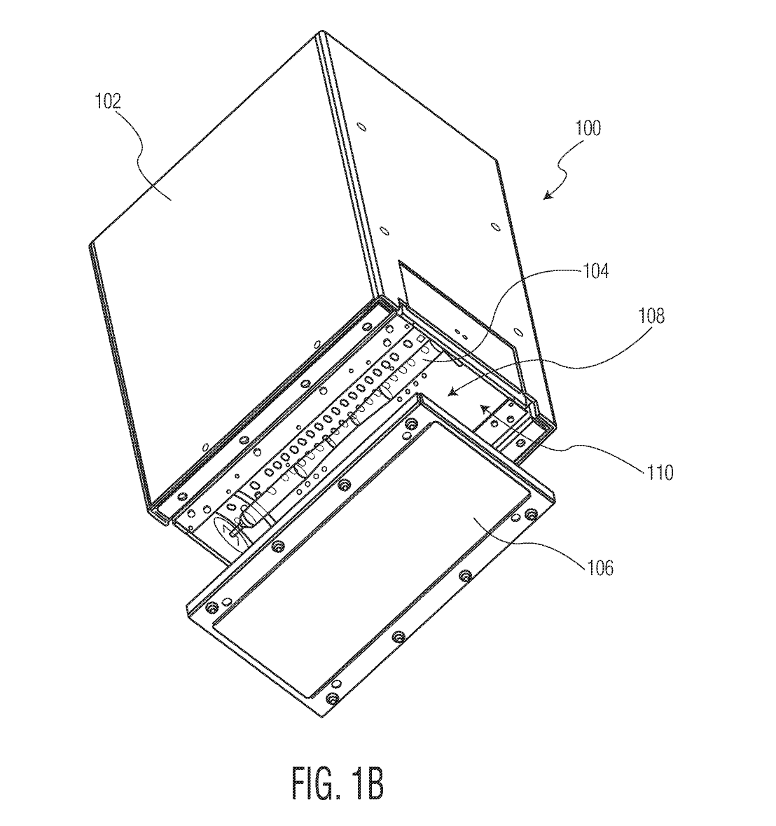

Referring now to the drawings, FIG. 1A illustrates UV lamp system 100 including an inventive gasket assembly 106. FIG. 1B is a partially exploded view of UV lamp system 100 (including housing 102), with gasket assembly 106 illustrated separate from the remainder of UV lamp system 100. By separating gasket assembly 106 from the remainder of UV lamp system 100 in FIG. 1B, certain other elements of UV lamp system 100 that are contained within housing 102 are visible including electrodeless bulb 104, reflector(s) 108, and reflector cavity 110. As described above, electric field energy from magnetrons (included within housing 102, but not visible in FIG. 1B) excite gas within electrodeless bulb 104, resulting in the emission of UV energy from electrodeless bulb 104. Such UV energy emitted from electrodeless bulb 104 may be used in applications such as, for example, UV curing applications.

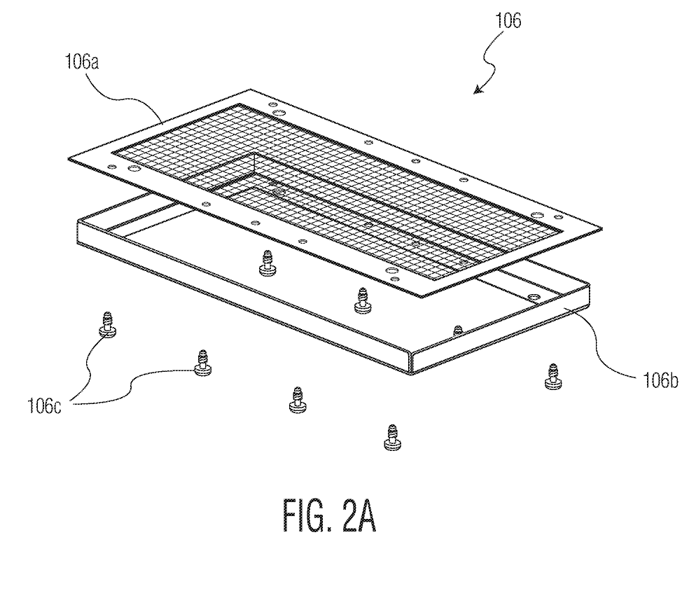

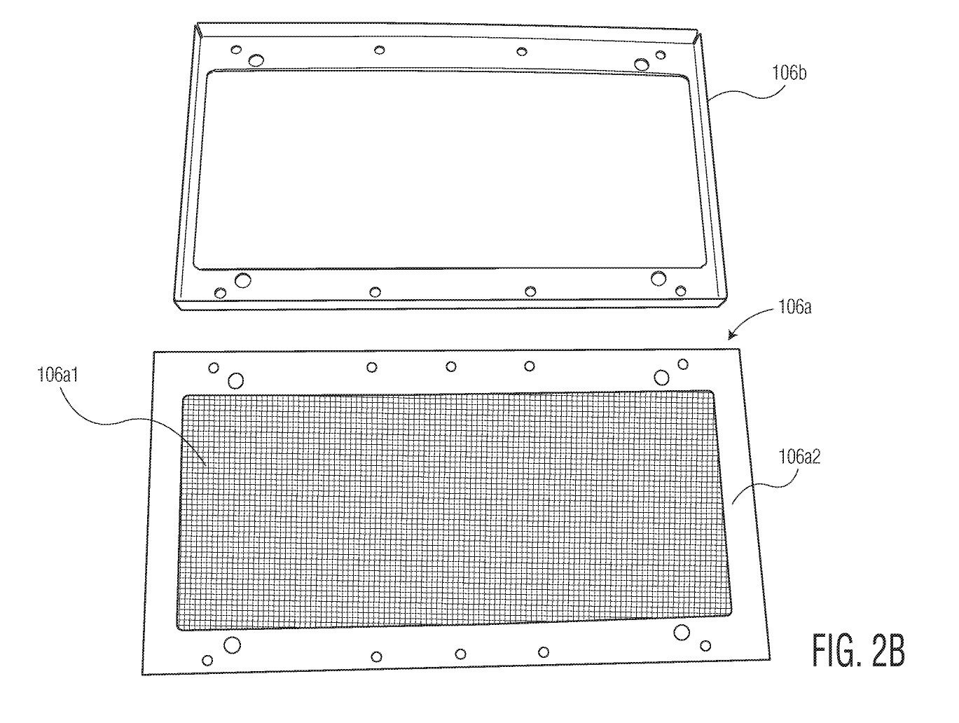

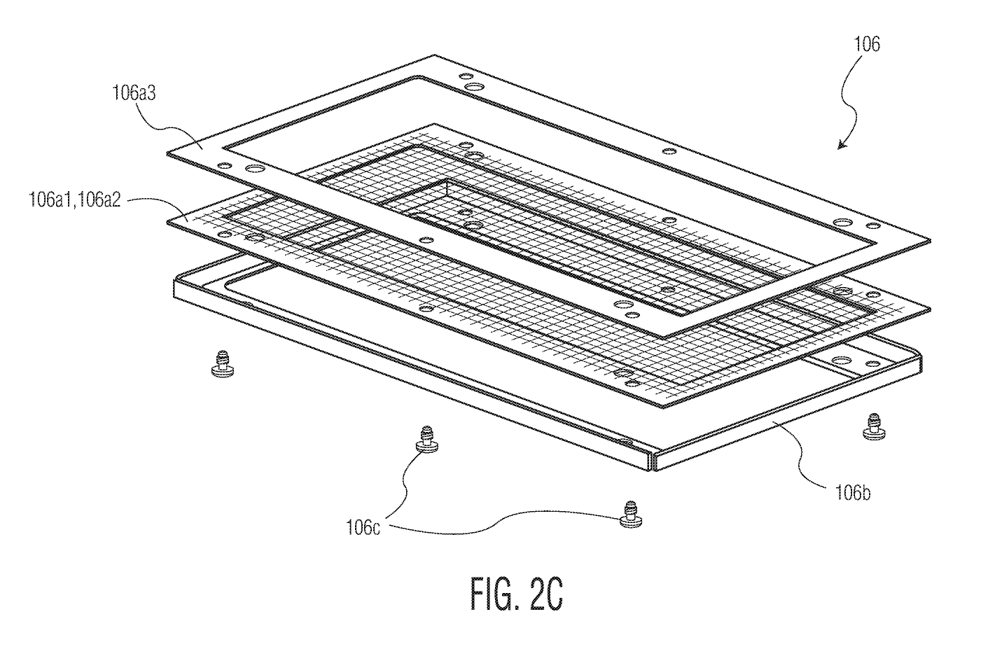

Exemplary gasket assembly 106 is shown in FIG. 2A, including element 106a (i.e., an RF screen, with elastomeric gasket material affixed to a perimeter area of the RF screen) and a frame member 106b. Fasteners 106c are used to couple element 106a and frame member 106b to the remainder of UV lamp system 100, as shown in FIG. 1A.

For example, in FIGS. 2A-2C: element 106a may represent an RF screen with solid pieces of elastomeric gasket material affixed thereto; element 106a may represent an RF screen with the elastomeric gasket material affixed/applied to the RF screen while the elastomeric gasket material is in a non-solid form (where the elastomeric gasket material later solidifies in contact with the RF screen as a single piece); among other potential representations of element 106a within the scope of the invention.

FIG. 2B also illustrates element 106a and frame member 106b separated from one another, in a side by side arrangement. Element 106a includes an RF screen 106a1, and an elastomeric gasket material piece 106a2 affixed to a first side of the RF screen, and an elastomeric gasket material piece 106a3 affixed to a second side of the RF screen (where the elastomeric gasket material piece 106a3 is not visible in FIG. 2B, but see FIG. 2C).

Aspects of the invention also relate to methods assembling a gasket assembly (e.g., gasket assembly 106 illustrated in the drawings) for use in a UV lamp system is provided. Exemplary methods include providing an RF screen (e.g., RF screen 106a1 illustrated in the drawings) (e.g., to shield microwave radiation leakage in connection with the UV system), and affixing an elastomeric gasket material (e.g., elastomeric gasket material pieces 106a2, 106a3) to the RF screen. For example, the elastomeric material may be affixed to a perimeter area of the RF screen. The elastomeric gasket material may be affixed to the RF screen: as multiple solid pieces, one to each side of the RF screen; as a non-solid material (e.g., in a mold, in a 3D printing application, etc.); etc.

In accordance with the inventive methods disclosed herein, after securing the elastomeric gasket material to the RF screen (thereby providing a “gasket assembly”), the gasket assembly may be installed in a UV lamp system (e.g., see FIGS. 1A-1B).

Although the invention illustrates a specific implementation of a gasket assembly (including an RF screen sandwiched between two elastomeric gasket material portions/layers), it is not limited thereto. As will be appreciated by those skilled in the art, various alternative configurations of the inventive gasket assembly (and related UV lamp system) are contemplated.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A gasket assembly for use in a UV lamp system, the gasket assembly comprising:
an RF screen; and
an elastomeric gasket material affixed to the RF screen.

2. The gasket assembly of claim 1 wherein the elastomeric gasket material is affixed to each side of the RF screen.

3. The gasket assembly of claim 1 wherein the elastomeric gasket material is affixed to a perimeter area of the RF screen.

4. The gasket assembly of claim 1 wherein the elastomeric gasket material is affixed to the RF screen using an adhesive.

5. The gasket assembly of claim 1 wherein the elastomeric gasket material includes conductive particles.

6. The gasket assembly of claim 1 wherein the elastomeric gasket material is a silicone-based material.

7. The gasket assembly of claim 1 further comprising a frame member, the RF screen, along with the elastomeric gasket material affixed thereto, being secured to the frame member.

8. A UV lamp system comprising:
a housing;
an electrodeless bulb configured to emit UV energy, the electrodeless bulb being positioned within the housing; and
a gasket assembly coupled to the housing adjacent the electrodeless bulb, the gasket assembly including an RF screen, and an elastomeric gasket material affixed to the RF screen.

9. The UV lamp system of claim 8 wherein the housing includes at least one magnetron for generating an electric field, and wherein the electrodeless bulb includes gas contained therein, the electric field exciting the gas such that the electrodeless bulb emits the UV energy.

10. The UV lamp system of claim 8 wherein the elastomeric gasket material is affixed to each side of the RF screen.

11. The UV lamp system of claim 8 wherein the elastomeric gasket material is affixed to a perimeter area of the RF screen.

12. The UV lamp system of claim 8 wherein the elastomeric gasket material is affixed to the RF screen using an adhesive.

13. The UV lamp system of claim 8 wherein the elastomeric gasket material includes conductive particles.

14. The UV lamp system of claim 8 wherein the elastomeric gasket material is a silicone-based material.

15. The UV lamp system of claim 8 further comprising a frame member, the RF screen, along with the elastomeric gasket material affixed thereto, being secured to the frame member.

16. A method of assembling a gasket assembly for use in a UV lamp system, the method comprising the steps of:
providing an RF screen; and
affixing an elastomeric gasket material to the RF screen.

17. The method of claim 16 wherein the affixing of the elastomeric gasket material to the RF screen includes affixing the elastomeric gasket material to each side of the RF screen.

18. The method of claim 16 wherein the affixing of the elastomeric gasket material to the RF screen includes affixing the elastomeric gasket material to a perimeter area of the RF screen.

19. The method of claim 16 further comprising securing the RF screen, including the elastomeric gasket material affixed thereto, to a frame member included as part of the gasket assembly.

20. The method of claim 16 further comprising installing the gasket assembly, including the RF screen with the elastomeric gasket material affixed thereto, in a UV lamp system.
